(19) United States
(12) Patent Application Publication
(10) Pub. No.: US 2016/0230959 A1
(43) Pub. Date: Aug. 11, 2016

(54) REFLECTING STRUCTURE OF LAMP

(71) Applicant: Taiwan Network Computer & Electronic Co., Ltd., New Taipei City (TW)

(72) Inventors: Chia-Mei PENG, Ping-Chen City (TW); Hsieh-Chen CHUANG, New Taipei City (TW); Ping-Han CHUANG, New Taipei City (TW)

(21) Appl. No.: 14/620,166

(22) Filed: Feb. 11, 2015

(51) Int. Cl. F21V 7/09

(52) U.S. Cl. CPC F21V 7/09

(57) ABSTRACT

The reflecting structure includes at least one light source; and at least one reflector in which the light source is disposed to emit light, wherein the reflector includes a light intercepting plate and a main body joined to the light intercepting plate; the light intercepting plate includes at least one light intercepting surface, at least one reflecting surface extending from the light intercepting plane perpendicularly toward an outer surface of the light intercepting plate and a first positioning structure; the main body is joined to the light intercepting surface and includes a second positioning structure and a plurality of reflecting inner surfaces reflecting light direct from the light source and light reflected by the reflecting surface, and each of the reflecting inner surfaces has an inclined angle different from the inclined angle of other of the reflecting inner surfaces.

### BACKGROUND OF THE INVENTION

1. Field of the Invention

The invention relates to a reflecting structure of a lamp, and more particularly to a reflecting structure suitable for vehicle head lights and street projecting lamps, capable of adjusting illuminating length and to reflect all light to a region to be illuminated.

2. Description of the Related Art

FIGS. 1A and 1B depict a conventional vehicle head light and optical path thereof. A reflector 01 has an inner surface serving as a reflecting surface. The reflector 01 has a circular arc surface 006 and an inclined surface 007. A light tube 002 is fitted to preset holes formed in the reflector 01. A shielding sheet 003 is fixed to the circular arc surface 006 through a frame 013. The shielding sheet 003 shields the light tube 002 to prevent light from the light tube 002 from dazzling a driver in a coming car, whereby high beam of the head light does not affect the driver in the coming car.

Referring to FIG. 1A, when the light tube 002 illuminates, an emitting center 005 generates light beams of 360°. A part of the light beams 009 are shielded by the shielding sheet 003. Some of these light beams are reflected to the reflector 01 and reflected by the reflector 01 to propagate out of the reflector 01, and some of these light beams cannot leave the reflector 01. Some light beams 010 are reflected by an arc-shaped reflecting surface on a top of the reflector and obstructed by the shielding sheet 003. Therefore, the reflector with such a shielding sheet has a low illuminating efficiency.

FIG. 1B depicts the optical path of the light from the light tube 002. Light 011 propagates under a horizontal line, and light 012 propagates above the horizontal line. The light 012 may dazzle a driver in a coming car, which is the problem that even the shielding sheet 003 is used still cannot be solved. Therefore, such a conventional reflector reduce illuminating effect and cannot solve the dazzling problem.

Taiwan patent 1378871 “Headlamp Structure with Reflective Substrate”, discloses a headlamp structure having a reflective substrate. The headlamp structure includes a reflective substrate, a reflector and a lens. Light from a light source is reflected twice and refracted once to reach an illuminating region. To solve the dazzling problem, a hollow cylinder is disposed between the light source and a light reflecting region. The hollow cylinder however occupies a considerable space and reduces the illuminating efficiency.

### BRIEF SUMMARY OF THE INVENTION

The invention provides a device. The reflecting structure in accordance with an exemplary embodiment of the invention includes at least one light source; and at least one reflector in which the light source is disposed to emit light, wherein the reflector includes a light intercepting plate and a main body joined to the light intercepting plate; the light intercepting plate includes at least one light intercepting surface, at least one reflecting surface extending from the light intercepting plane perpendicularly toward an outer surface of the light intercepting plate and a first positioning structure; the main body is joined to the light intercepting surface and includes a second positioning structure and a plurality of reflecting inner surfaces reflecting light direct from the light source and light reflected by the reflecting surface, and each of the reflecting inner surfaces has an inclined angle different from the inclined angle of other of the reflecting inner surfaces.

In another exemplary embodiment, the light intercepting plate comprises at least one horizontal light intercepting plane and at least one inclined light intercepting plane.

In yet another exemplary embodiment, the light intercepting surface comprises at least one arc-shaped reflecting surface.

In another exemplary embodiment, the light intercepting surface comprises at least one curved reflecting surface.

In yet another exemplary embodiment, the light intercepting surface comprises at least one arc-shaped surface, and at least one conical reflecting surface extending from the light intercepting plane to the outer surface of the light intercepting plate perpendicular to the light intercepting plane is formed in front of the arc-shaped surface; the conical reflecting surface comprises a plurality of arc-shaped inclined surfaces connected to each other, and each of the arc-shaped inclined surfaces has an inclined angle gradually increased from the arc-shaped inclined surface at a bottom of the conical reflecting surface to the arc-shaped inclined surface at a top of the conical reflecting surface.

In another exemplary embodiment, the light intercepting surface comprises at least one arc-shaped surface, and at least one conical reflecting surface extending from the light intercepting plane to the outer surface of the light intercepting plate perpendicular to the light intercepting plane is formed in front of the arc-shaped surface and on one side of a perpendicular light intercepting surface disposed on the light intercepting plate; the conical reflecting surface comprises a plurality of arc-shaped inclined surfaces connected to each other, and each of the arc-shaped inclined surfaces has an inclined angle gradually increased from the arc-shaped inclined surface at a bottom of the conical reflecting surface to the arc-shaped inclined surface at a top of the conical reflecting surface.

In yet another exemplary embodiment, the reflecting surface comprises at least one arc-shaped surface, and a movable light intercepting surface connected to an electromagnet is formed in front of the arc-shaped surface and at least one conical reflecting surface extending from the movable light intercepting surface to the outer surface of the light intercepting plate perpendicular to the light intercepting plane is formed; the conical reflecting surface comprises a plurality of arc-shaped inclined surfaces connected to each other, and each of the arc-shaped inclined surfaces has an inclined angle gradually increased from the arc-shaped inclined surface at a bottom of the conical reflecting surface to the arc-shaped inclined surface at a top of the conical reflecting surface.

In another exemplary embodiment, the main body comprises at least one conical reflecting surface, and the conical reflecting surface comprises a plurality of arc-shaped inclined surfaces connected to each other, and each of the arc-shaped inclined surfaces has an inclined angle gradually increased from the arc-shaped inclined surface at a bottom of the conical reflecting surface to the arc-shaped inclined surface at a top of the conical reflecting surface; two planes extend outwards from two lateral sides of the main body respectively.

In yet another exemplary embodiment, the reflecting structure includes a middle semi-circular inclined surface extending from a bottom of the main body toward an outer side of the bottom of the main body slantly and at least one bottom conical curved surface extending from a bottom of the middle semi-circular inclined surface toward an inner side of the bottom of the main body slantly, wherein the conical reflecting surface comprises a plurality of arced inclined surfaces connected to each other, and each of the arced inclined surfaces has an inclined angle gradually increased from the arced inclined surface at a bottom of the conical reflecting surface to the arced inclined surface at a top of the conical reflecting surface; two planes extend outwards from two lateral sides of the main body respectively.

In another exemplary embodiment, the reflecting structure further includes a panel extending from a bottom of the reflector and at least one warning light source disposed on the panel.

In yet another exemplary embodiment, the reflector is disposed upside down in an anti-dust cover comprising at least one transparent plate.

In another exemplary embodiment, a bottom of the reflector is connected to an end surface of a hollow cylindrical frame, and another end surface of the hollow cylindrical frame is connected to a lens.

In yet another exemplary embodiment, the reflector includes a bottom with uneven height.

In another exemplary embodiment, the reflector further includes a plurality of fins disposed on the outer surface of the light intercepting plate.

In yet another exemplary embodiment, the light intercepting plate includes at least one horizontal light intercepting surface and at least one vertical light intercepting surface with uneven height, and the vertical light intercepting surface is disposed on an inner surface of a bottom of the light intercepting plate and perpendicular to the horizontal light intercepting surface.

A reflecting structure of a lamp in accordance with an exemplary embodiment of the invention includes at least one light source; and at least one reflector in which the light source is disposed to emit light, wherein the reflector includes at least one light intercepting plate including a plurality of reflecting surfaces; the light intercepting plate further includes at least one light intercepting plane and two conical curved reflecting surfaces formed on an upper side and a lower side of the light intercepting plan; each of the conical curved reflecting surface includes a plurality of arced inclined surfaces connected to each other, and each of the arced inclined surfaces has an inclined angle gradually increased from the arced inclined surface at a bottom of the conical reflecting surface to the arced inclined surface at a top of the conical reflecting surface; the conical curved reflecting surfaces are non-symmetrical with the light intercepting plane; the reflector includes at least one positioning structure.

In another exemplary embodiment, the light intercepting plate further includes at least one horizontal light intercepting plane and at least one inclined light intercepting plane.

In yet another exemplary embodiment, the reflector further includes at least one arc-shaped reflecting surface disposed on a vertex of the conical curved reflecting surface and above the light intercepting plane.

In another exemplary embodiment, the reflector further includes at least one arc-shaped reflecting surface disposed on a vertex portion of the conical curved reflecting surface and below the light intercepting plane.

In yet another exemplary embodiment, the reflecting structure of the invention further includes a panel extending from a bottom of the reflector and at least one alarm light source disposed on the panel.

In another exemplary embodiment, a bottom of the reflector is connected to an end surface of a hollow cylindrical frame, and another end surface of the hollow cylindrical frame is connected to a lens; the reflector is disposed in an anti-dust cover including at least one transparent member.

In yet another exemplary embodiment, a bottom of the reflector is connected to a transparent plate.

In another exemplary embodiment, a bottom of the reflector is connected to a light emitting module.

In yet another exemplary embodiment, the reflector comprises a bottom with uneven height.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1A and 1B depicts a conventional vehicle head light;

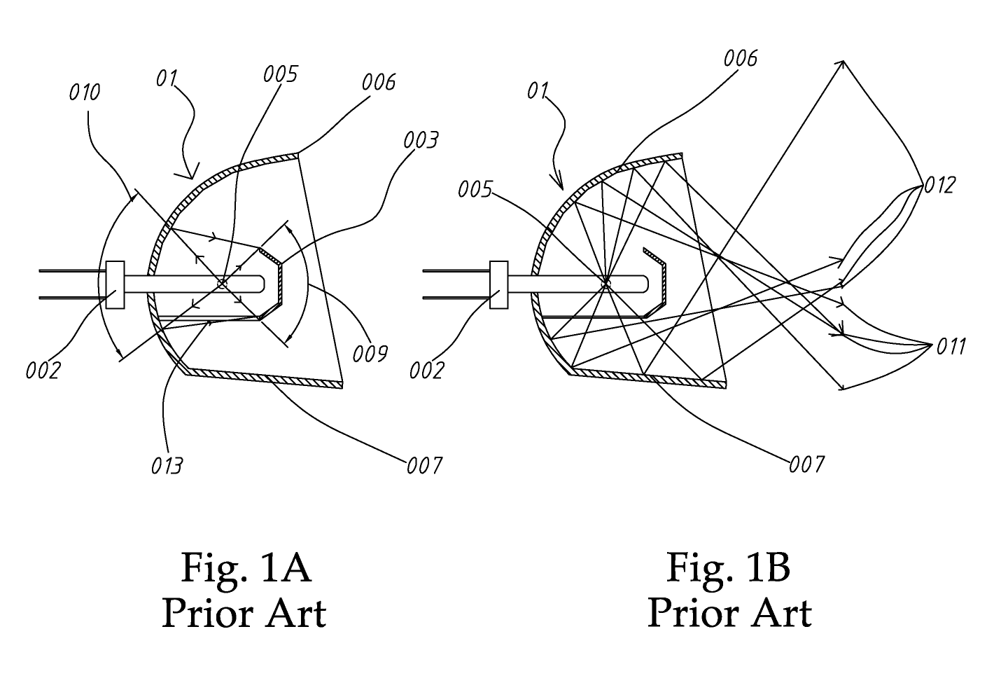

FIGS. 2A and 2B depict the first embodiment of a reflecting structure of the invention;

FIGS. 3A and 3B depict the second embodiment of a reflecting structure of the invention;

FIGS. 4A and 4B depict the third embodiment of a reflecting structure of the invention;

FIGS. 5A and 5B depict the fourth embodiment of a reflecting structure of the invention;

FIGS. 6A to 6D depict the fifth to eighth embodiments of a reflecting structure of the invention;

FIGS. 7A and 7B depict the ninth embodiment of a reflecting structure of the invention;

FIGS. 8A and 8B show optical paths of the first to ninth embodiments of a reflecting structure of the invention;

FIGS. 9A and 9B depict the tenth embodiment of a reflecting structure of the invention;

FIGS. 10A to 10D depict the eleventh to fourteenth embodiments of a reflecting structure of the invention;

FIGS. 11A and 11B depict the fifteenth and sixteenth embodiments of a reflecting structure of the invention;

FIG. 12 depicts the tenth embodiment of a reflecting structure of the invention;

FIGS. 13A and 13B depict the eighteenth and nineteenth embodiments of a reflecting structure of the invention;

FIGS. 14A and 14B depict the first example and second example of a reflecting structure of the invention applied to a head light;

FIG. 15 depicts the third example of a reflecting structure of the invention applied to a head light; and

FIG. 16 depicts the twentieth embodiment of a reflecting structure of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

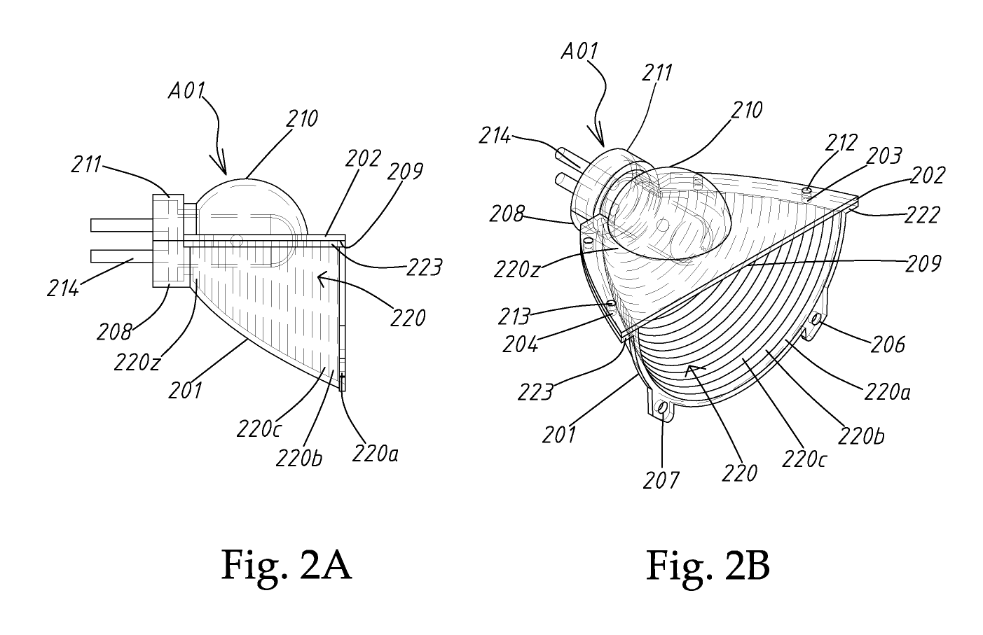

Referring to FIGS. 2A and 2B, a reflecting structure of the invention includes a reflector A01 and a light source 214. The reflector A01 includes a main body 201 and a light intercepting plate 202. The light source 214 which can be a light bulb, a light tube or a light emitting diode light source is disposed in the reflector 201. The light intercepting plate 202 includes at least one plane serving as a light intercepting surface 209. In this embodiment, the light intercepting surface 209 is disposed on an inner surface of the light intercepting plate 202 and is a horizontal plane. An arc-shaped reflecting surface 210 extends from the light intercepting plane 209 perpendicularly toward an outer surface of the light intercepting plate 202. The arc-shaped reflecting surface 210 reflects light from the light source 214 inward and under the light intercepting plate 202. The light intercepting surface 209 intercepts the light propagating toward a planar region surrounding the arc-shaped reflecting surface 210, the light propagating toward a peripheral region of the reflector A01). A position member 211 having a through hole is disposed on one lateral side of the arc-shaped reflecting surface 210. Two positioning members 212 and 213 are disposed on two lateral sides of the light intercepting plate 202 so as to join the main body 201. The positioning members 212 and 213 are through holes in this embodiment, but they can be grooves or ribs in other embodiments. The main body 201 is joined to the light intercepting surface 209 and includes at least one conical curved reflecting surface 220. The conical curved reflecting surface 220 includes a plurality of arc-shaped inclined surfaces 220a, 220b, 220c to 220z connected to each other. Each of the arc-shaped inclined surfaces 220a, 220b, 220c to 220z has an inclined angle different from the inclined angle of other arc-shaped inclined surfaces 220a, 220b, 220c to 220z. The inclined angle is gradually increased from the inclined angle of the arc-shaped inclined surface at a bottom of the main body 201 (the arc-shaped inclined surface 220a) which is smallest to the inclined angle of the arc-shaped inclined surface closest to a vertex of the conical curved reflecting surface 220 (the arc-shaped inclined surface 220z) which is the greatest. A positioning member 208 with a through hole is disposed on the vertex of the conical curved reflecting surface 220. The positioning member 208 and the positioning member 211 are used to hold the light source 214 so as to secure the light source 214. Two flanges 222 and 223 extends from the main body 201, and two positioning members 203 and 204 are disposed on the flanges 222 and 223 respectively to join the light intercepting plate 202. The positioning member 203 and 204 are through holes in this embodiment, but they can be grooves or ribs in other embodiment. Two positioning members 206 and 207 are disposed on an outer surface of the main body 201 to join an external member such as anti-dust cover (not shown). In this embodiment, the light source 214 is a light tube horizontally disposed under the arc-shaped reflecting surface 210. The reflector A01 can be disposed upside down within an anti-dust cover with a transparent plate.

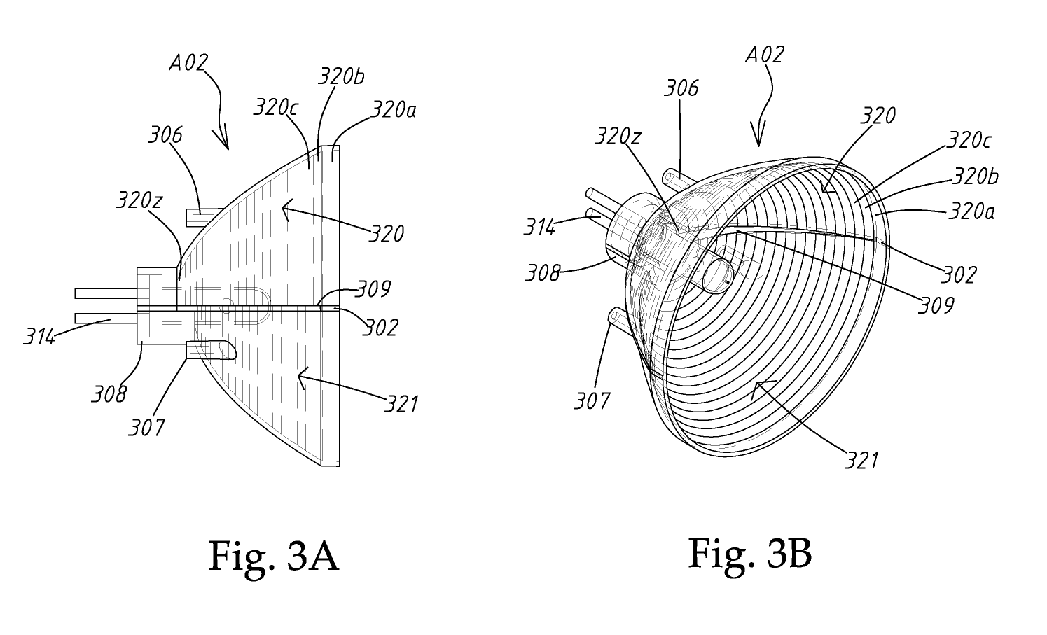

Referring to FIGS. 3A and 3B, a reflecting structure of the invention includes a reflector A02 and a light source 314. The reflector A02 includes a light intercepting plate 302 including a plurality of reflecting surfaces. The light intercepting plate 302 has an upper plane serving as a light intercepting surface 309. A conical curved reflecting surface 320 extends upwards from the light intercepting surface 309, and another conical curved reflecting surface 321 extends downwards from the light intercepting surface 309. The conical curved reflecting surface 320 includes a plurality of arc-shaped inclined surfaces 320a, 320b, 320c to 320z connected to each other. Each of the arc-shaped inclined surfaces 320a, 320b, 320c to 320z has an inclined angle different from the inclined angle of other arc-shaped inclined surfaces 320a, 320b, 320c to 320z. The inclined angle is gradually increased from the inclined angle of the arc-shaped inclined surface at a bottom of the reflector A02 (the arc-shaped inclined surface 320a) which is smallest to the inclined angle of the arc-shaped inclined surface closest to a vertex of the conical curved reflecting surface 320 (the arc-shaped inclined surface 320z) which is the greatest. The conical curved reflecting surface 321 has a structure similar to the conical curved reflecting surface 320 but a size different from the conical curved reflecting surface 320. The conical curved reflecting surfaces 320 and 321 are non-symmetrical. The light intercepting surface 309 intercepts light propagating toward gaps on the conical curved reflecting surfaces 320 and 321, whereby the reflector A02 become a completely closed structure. A positioning member 308 is disposed on a vertex of the reflector A02 to hold the light source 314 so as to secure the light source 314. Two positioning members 306 and 307 are disposed on an outer surface of the reflector A02 to join an external member (not shown). In this embodiment, the light source 314 is a light tube horizontally disposed at the vertex of the reflector A02. The light source 314 can be inclined according to requirements.

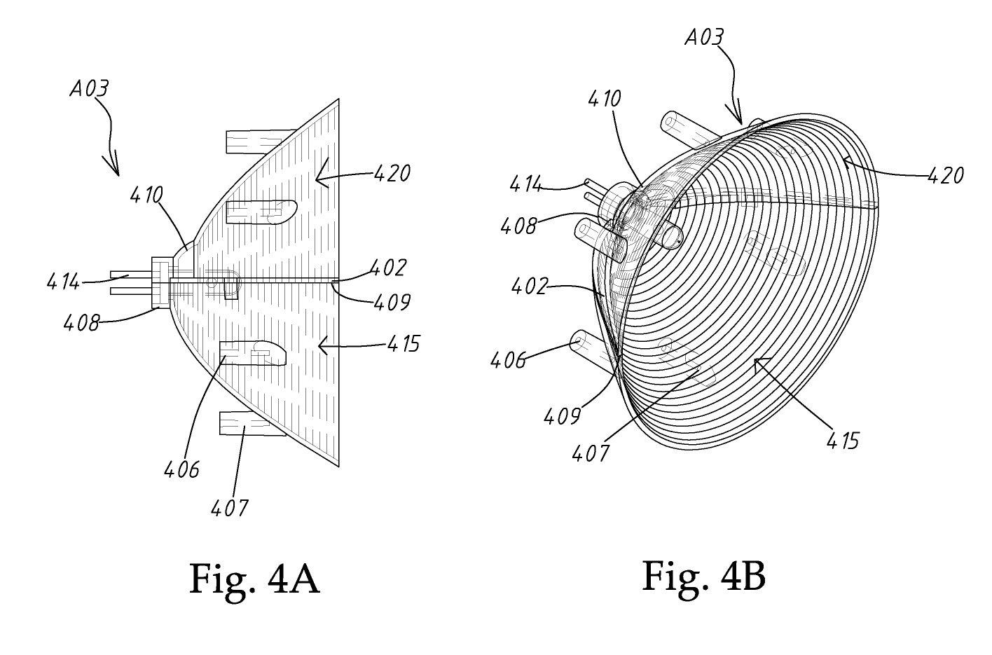

Referring to FIGS. 4A and 4B, a reflecting structure of the invention includes a reflector A03 and a light source 414. The reflector A03 includes a light intercepting plate 402 including a plurality of reflecting surfaces. The light intercepting plate 402 has a lower plane serving as a light intercepting surface 409. An arc-shaped reflecting surface 410 extends upwards from the light intercepting surface 409 perpendicularly. The arc-shaped reflecting surface 410 reflects light from the light source 414 inward to under the light intercepting plate 402. At least one conical curved reflecting surface 420 extends upward from the light intercepting surface 409 and connects the arc-shaped reflecting surface 410. The conical curved reflecting surface 420 has a structure similar to the conical curved reflecting surface 320 of FIGS. 3A and 3B. Another conical curved reflecting surface 415 extends downwards from the light intercepting surface 409 perpendicularly. The conical curved reflecting surface 415 has a structure similar to the conical curved reflecting surface 220 of FIGS. 2A and 2B. The conical curved reflecting surfaces 415 and 420 are non-symmetrical. The light intercepting surface 409 intercepts light propagating toward gaps on the conical curved reflecting surfaces 415 and 420, whereby the reflector A03 become a completely closed structure. A positioning member 408 is disposed on a vertex of the reflector A03 to hold the light source 414 so as to secure the light source 414. Two positioning members 406 and 407 are disposed on an outer surface of the reflector A03 to join an external member (not shown). In this embodiment, the light source 314 is a light tube disposed at the vertex of the reflector A02. In another embodiment, at least one arc-shaped reflecting surface and at least one conical curved reflecting surface extend downwards from the light intercepting surface 409. The two arc-shaped reflecting surfaces can be symmetrical or non-symmetrical, but the two conical curved reflecting surfaces are non-symmetrical.

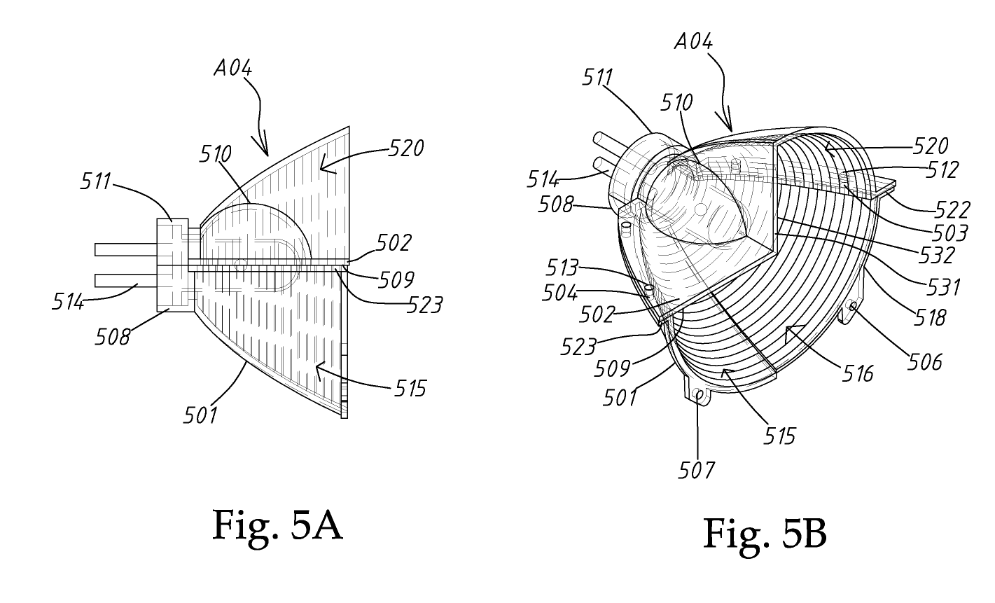

Referring to FIGS. 5A and 5B, a reflecting structure of the invention includes a reflector A04 and a light source 514. The reflector A04 includes a main body 501 and a light intercepting plate 502. The light intercepting plate 502 has an inner plane serving as a light intercepting surface 509 which is a horizontal plane. An arc-shaped reflecting surface 510 extends upwards from the light intercepting surface 509 toward an outer surface of the intercepting plate 502. The arc-shaped reflecting surface 510 reflects light from the light source 514 inwards and under the light intercepting plate 502. A positioning member 511 with a through hole is disposed on one lateral side of the arc-shaped reflecting surface 510. At least one conical curved reflecting surface 520 extends from the light intercepting surface 509 upward and is disposed in front of the arc-shaped reflecting surface 510. The conical curved reflecting surface 520 reflects light outward from the reflector A04. In this embodiment, the conical curved reflecting surface 520 is disposed on one half portion of the light intercepting plate 502. The conical curved reflecting surface 520 has a structure similar to the conical curved reflecting surface 320 of FIGS. 3A and 3B. The light intercepting plate 502 has a vertical plate 531 connected to one lateral side of the conical curved reflecting surface 520, whereby the conical curved reflecting surface 520 is closed. The vertical plate 531 has an inner plane serving as a light intercepting surface 532. Two positioning members 512 and 513 are disposed on the light intercepting plate 502. At least one of the positioning members 512 and 513 is a through hole. The main body 501 is joined to the light intercepting surface 509 of the light intercepting plate 502 and includes two conical curved reflecting surfaces 515 and 516. Each of the conical curved reflecting surfaces 515 and 516 has a structure similar to the conical curved reflecting surface 220 of FIGS. 2A and 2B. The main body 501 has a positioning member 508 with a through hole to hold the light source 514. The main body 501 further has two flanges 522 and 523 extending from two upper edges outwards. Two positioning members 503 and 504 are disposed on the flanges 522 and 523 respectively and used to join the light intercepting plate 502. Two positioning members 506 and 507 are disposed on an outer surface of the main body 501 and used to join an external member (not shown). In this embodiment, the light source 514 is horizontally disposed on the reflector A04.

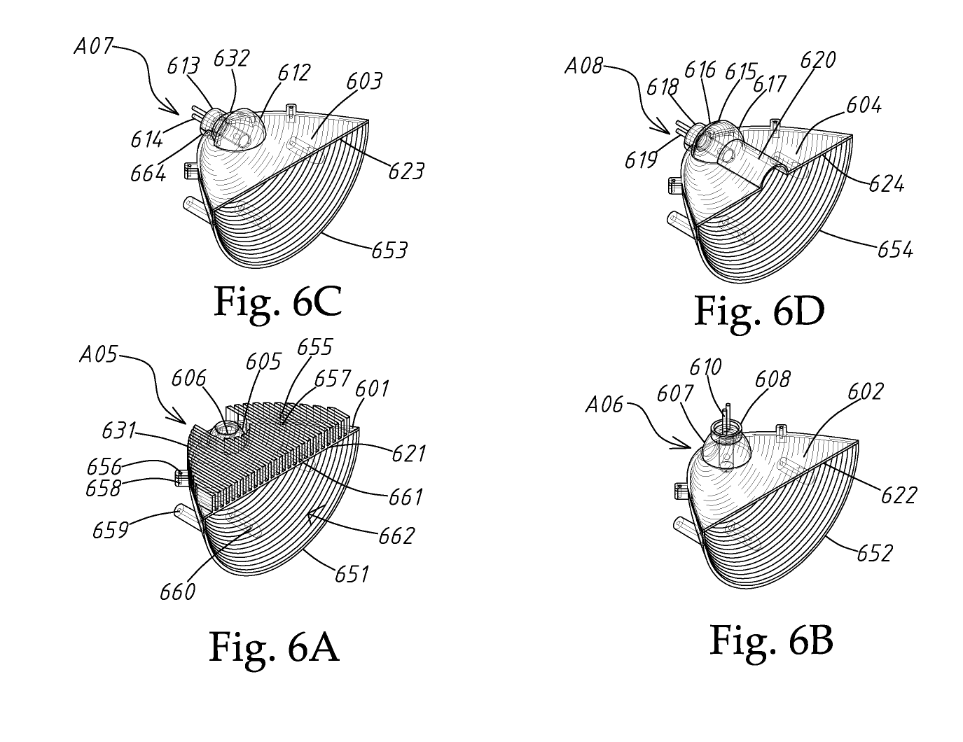

Referring to FIGS. 6A and 6D, a reflecting structure of the invention includes a light intercepting plate and a main body. Referring to FIG. 6A, a reflector A05 includes a light intercepting plate 601 and a main body 651. The light intercepting plate 601 has an inner surface which is a horizontal plane and serves as a light intercepting surface 621. At least one conical curved reflecting surface 605 extends from the light intercepting surface 621 upwards. At least one light emitting diode 606 is disposed on an inner surface at the vertex of the conical curved reflecting surface 605. In other embodiment, a through hole is formed at the vertex of the conical curved reflecting surface 605 for a light tube or LED module inserted thereinto and vertically disposed. A plurality of fins 631 are disposed on an outer surface of the light intercepting plate 601 for heat dissipation of the light emitting diode 606. Two positioning member 655 and 656 are disposed on two lateral sides of the light intercepting plate 601. At least one of the positioning member 655 and 656 is a through hole. The main body 651 includes at least one conical curved reflecting surface 662. The conical curved reflecting surface 662 has a structure similar to the conical curved reflecting surface 220 of FIGS. 2A and 2B. Two flanges extend from two lateral sides of the main body 651, and two positioning members 657 and 658 are disposed on the flanges respectively. At least one of the positioning members 657 and 658 is a through hole. Three positioning members 659, 660 and 661 with through holes are disposed on an outer surface of the main body 651. In other embodiment, a plurality of fins are disposed on the outer surface of the main body 651. Referring to FIG. 6B, a reflecting structure of the invention includes a reflector A06 and a light source 610. The reflector A06 includes a light intercepting plate 602 having an inner surface which is a horizontal plane and serves as a light intercepting surface 622. An arc-shaped reflecting surface 607 extends from the light intercepting surface 622 upwards. A positioning member 608 with a through hole is disposed on a vertex of the arc-shaped reflecting surface 607. The light source 610, a light tube, is vertically disposed in the reflector A06. The reflector A06 further includes a main body 652 having a structure similar to the main body 651 of FIG. 6A. Referring to FIG. 6C, a reflecting structure of the invention includes a reflector A07 and a light source 614. The reflector A07 has a light intercepting plate 603 having an inner surface which is a horizontal plane and serves as a light intercepting surface 623. Two arc-shaped reflecting surfaces 612 and 632 extend from the light intercepting surface 623 upwards. The arc-shaped reflecting surfaces 612 and 632 can be concentric or nonconcentric. In this embodiment, the arc-shaped reflecting surfaces 612 and 632 are concentric and have different sizes. A positioning member 613 is disposed on one lateral side of the arc-shaped reflecting surface 632 to hold and fix the light source 614 horizontally. In another embodiment, a through hole is formed on the top of the arc-shaped reflecting surfaces 612 and 632 for receiving a light tube vertically. The reflector A07 further includes a main body 653 having a structure similar to the main body 651 of FIG. 6A, but the main body 653 has a positioning member 664 with a through hole to hold the light source 614. Referring to FIG. 6D, a reflecting structure includes a reflector A08 and a light source 619. The reflector A08 includes a light intercepting plate 604 and a main body 654. The light intercepting plate 604 has an inner surface which is a horizontal plane and serves as a light intercepting surface 624. An irregular reflecting surface 615 extends from the light intercepting surface 624 upwards. The irregular reflecting surface 615 includes a curved reflecting surface 616 and two arc-shaped reflecting surfaces 617 and 620. The curved reflecting surface 616 includes a plurality of arc-shaped inclined surfaces or curved surfaces having different inclined angles. A positioning member 618 with a through hole is disposed on one lateral side to hold and fix the light source 619. The main body 654 has a structure similar to the main body 653 of FIG. 6C.

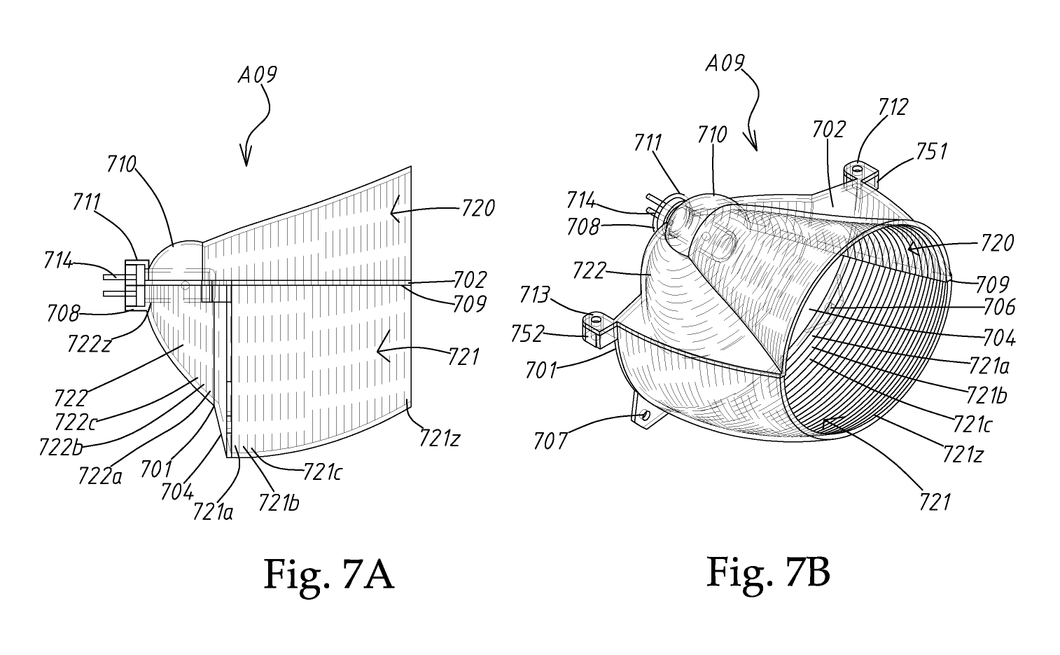

Referring to FIGS. 7A and 7B, a reflecting structure of the invention includes a reflector A09 and a light source 714. The reflector A09 includes a main body 701 and a light intercepting plate 702. The light intercepting plate 702 has an inner surface which is a horizontal plane and serves as a light intercepting surface 709. An arc-shaped reflecting surface 710 extends from the light intercepting surface 709 upwards. A positioning member 711 with a through hole is disposed on one lateral side of the arc-shaped reflecting surface 710. The arc-shaped reflecting surface 710 reflects light inwards and under the light intercepting plate 702. A conical curved reflecting surface 720 extends from the light intercepting surface 709 upwards and is disposed in front of the arc-shaped reflecting surface 710. In this embodiment, the arc-shaped reflecting surface 710 is connected to the conical curved reflecting surface 720. In another embodiment, the arc-shaped reflecting surface 710 can have no connection to the conical curved reflecting surface 720. The conical curved reflecting surface 720 reflects light outwards from the reflector A09. The conical curved reflecting surface 720 has a structure similar to the conical curved reflecting surface 420. The light intercepting plate 702 has two positioning members 712 and 713. At least one of the positioning members 712 and 713 is a through hole. The main body 701 is joined to the light intercepting surface 709 of the light intercepting plate 702. The main body 701 has a cascading reflecting surface and includes a top conical curved reflecting surface 722, a bottom conical curved reflecting surface 721 and a middle semi-circular inclined surface 704. The top conical curved reflecting surface 722 includes a plurality of arc-shaped inclined surfaces 722a, 722b, 722c to 722z connected to each other. Each of the arc-shaped inclined surfaces 722a, 722b, 722c to 722z has an inclined angle gradually increased from the arc-shaped inclined surface 722a connected to a top of the middle semi-circular inclined surface 704 to the arc-shaped inclined surface 722z at the vertex of the top conical curved reflecting surface 722. A positioning member 708 is disposed on the vertex of the top conical curved reflecting surface 722 to hold and fix the light source 714. The middle semi-circular inclined surface 704 is a semi-circular inclined surface extending from a bottom of the conical curved reflecting surface 722 outwards. The bottom conical curved reflecting surface 721 is connected to a bottom of the middle semi-circular inclined surface 704 and includes a plurality of arc-shaped inclined surfaces 721a, 721b, 721c to 721z connected to each other. Each of the arc-shaped inclined surfaces 721a, 721b, 721c to 721z has an inclined angle gradually increased from the arc-shaped inclined surface 721a, which is connected to the bottom of the middle semi-circular inclined surface 704, to the arc-shaped inclined surface 721z, which is closest to the vertex of the top conical curved reflecting surface 722. Two positioning members 751 and 752 are disposed on two flanges extending from an upper surface of the main body 701 respectively to join the light intercepting plate 702. Two positioning members 706 and 707 are disposed on an outer surface of the main body 701 to join an external member (not shown). In this embodiment, the light source 714 is a light tube horizontally disposed in the reflector A09.

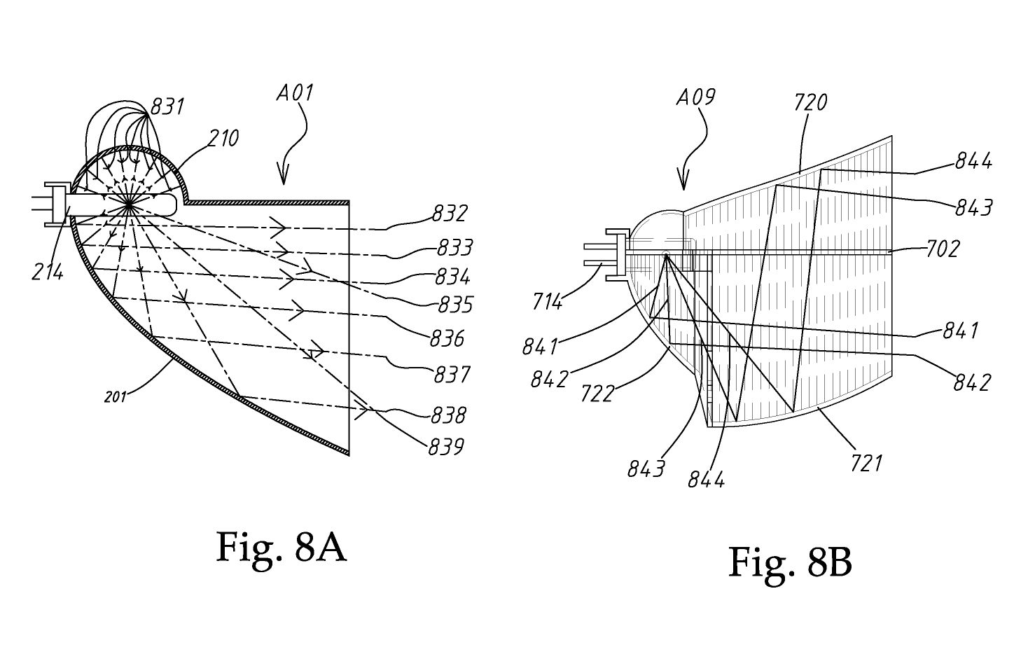

FIG. 8A shows paths of light propagating in the reflector A01. Light 831 from an upper half of the light source 214 emits to the arc-shaped reflecting surface 210 and is reflected by the arc-shaped reflecting surface 210 to the main body 201. The light is reflected by the main body 201 again at different angles. Lights 835 and 839 directly emitted from the light source and lights 832, 833, 834, 836, 837 and 838 reflected by the main body 201 travel in predetermined directions. FIG. 8B shows paths of light propagating in the reflector A09. Lights 841 and 842 from the light source 714 is reflected by the top conical curved reflecting surface 722 to travel outwards. Lights 843 and 844 are reflected by the bottom conical curved reflecting surface 721 to travel upwards to the conical curved reflecting surface 720 and is reflected by the conical curved reflecting surface 721 to travel outwards.

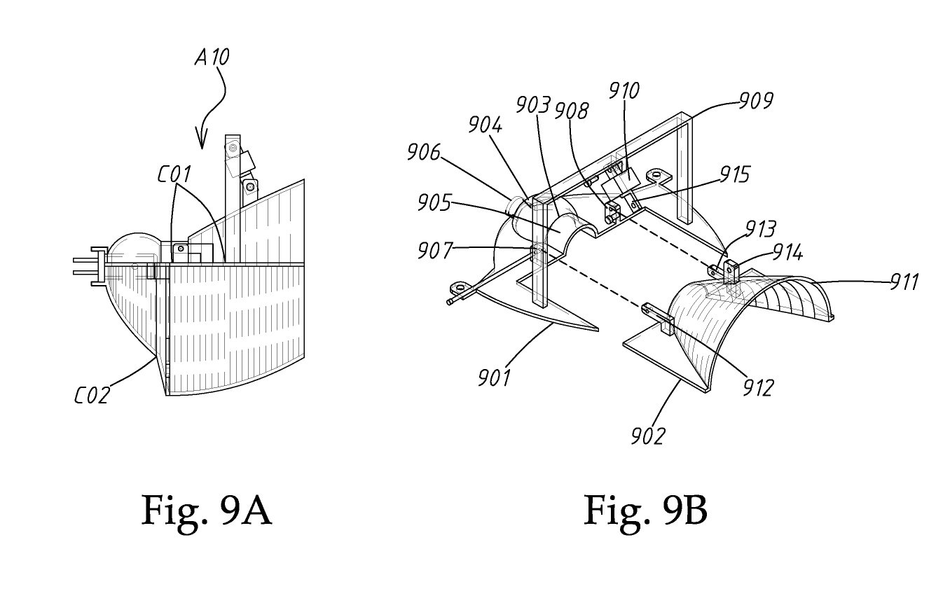

Referring to FIGS. 9A and 9B, a reflecting structure of the invention includes a reflector A10 including an inner surface serving as a reflecting surface. This embodiment has a structure similar to the embodiment of FIGS. 7A and 7B. The reflector A10 includes a light intercepting plate C01 and a main body C02. The light intercepting plate C01 has a movable light intercepting surface 902. The main body C02 has a same structure as the main body 701 of FIGS. 7A and 7B. The light intercepting plate C01 includes an irregular reflecting surface 903 formed on a light intercepting surface 901. The irregular surface 903 includes two arc-shaped surfaces 904 and 905. In another embodiment, the irregular reflecting surface 903 includes at least one curved surface. A positioning member 906 is disposed on one lateral side of the arc-shaped surface 904 to hold a light source. The reflector A10 further includes two columns 907 and 908 with through holes and a frame 909. An electromagnet 910 is disposed on middle inner side of the frame 909. A conical reflecting surface 911 extends from another movable light intercepting surface 902. The conical reflecting surface 911 has a same structure as the conical curved reflecting surface 320 of FIGS. 3A and 3B. A protrusion 914 with through holes is disposed on an outer surface of the conical curved reflecting surface 911. Two L-shaped columns 912 and 913 are movably disposed on the columns 907 and 908 of the light intercepting surface 901. The protrusion 914 is movably disposed on a retractable rod 915 of the electromagnet 910, whereby the light intercepting surface 902 become a movable device capable of changing its elevation angle to change an illuminating distance of the light reflected by the conical curved reflecting surface 911. The reflector A10 is applied to switch between high beam and low beam. In this embodiment, the light intercepting surface 902 is movable, if there are a simpler structure having the same effect belongs to an effective replacement.

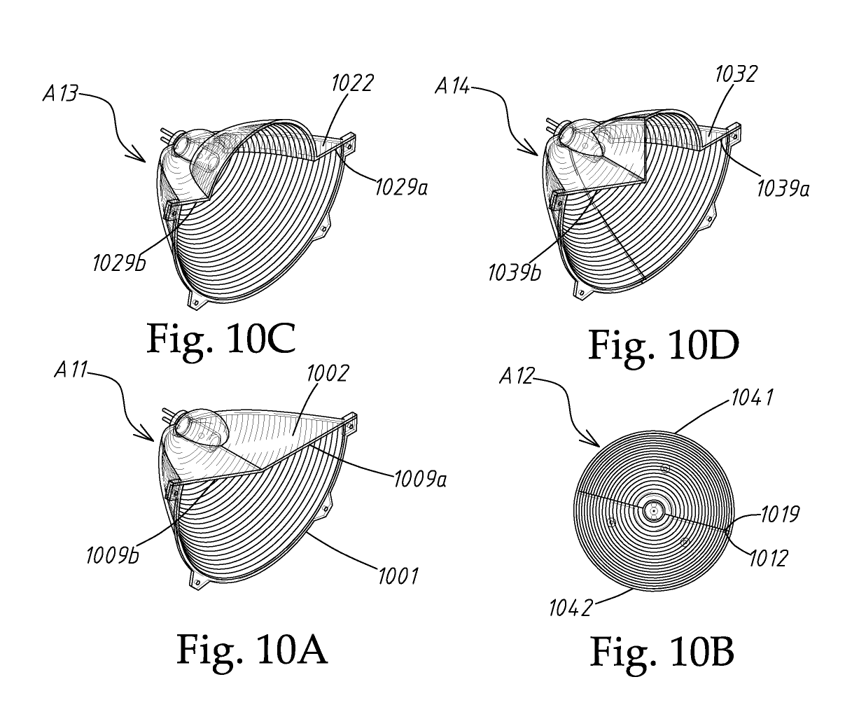

Referring to FIGS. 10 A to 10D, a reflector A11 includes a light intercepting plate 1002 and a main body 1001. The reflector A11 has a structure similar to the reflector A01 of FIGS. 2A and 2B. The light intercepting plate includes a horizontal light intercepting surface 1009a and an inclined light intercepting surface 1009b. The light intercepting surfaces 1009a and 1009b enable light travel horizontally on the left hand side of the reflector A11 and travel slantly on the right hand side of the reflector A11. Referring to FIG. 10B, a reflector A12 has a light intercepting plate 1012 inclined by an angle. The light intercepting plate 1012 has a light intercepting surface 1019. Two conical curved reflecting surfaces 1041 and 1042 extend from the light intercepting plate 1012 upwards and downwards to form a non-symmetrical structure. The reflector A12 generates a light pattern which has smaller illuminating width on left hand side and larger brightness on right hand side than the reflector A11. Referring to FIG. 10C, a reflector A13 has a structure similar to the reflector A03 of FIGS. 4A and 4B. The reflector A13 has a light intercepting plate 1022 includes a horizontal light intercepting surface 1029a and an inclined light intercepting surface 1029b. Referring to FIG. 10D, a reflector A14 includes a light intercepting plate 1032 and a main body 1031. The reflector A14 has a structure similar to the reflector A04 of FIGS. 5A and 5B. The light intercepting plate 1032 has a horizontal light intercepting surface 1039a and an inclined light intercepting surface 1039b.

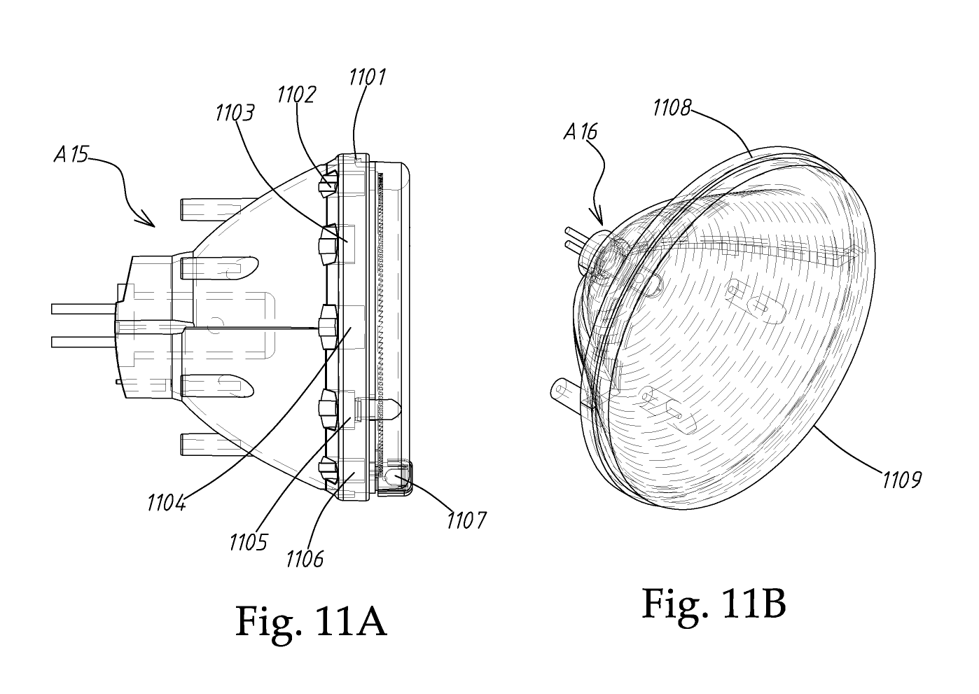

Referring to FIGS. 11A and 11B, a reflecting structure of the invention includes a reflector A15. The reflector A15 has a structure similar to the reflector A03 of FIGS. 4A and 4B. The reflector A15 includes a plurality of positioning members 1101, 1102, 1103 to 1106 which are grooves to join and position a LED light emitting module 1107. A reflector A16 has a structure similar to the reflector A03 of FIGS. 4A and 4B. The reflector A16 includes a positioning member 1108 which is a groove to join and position an external member, a transparent plate 1109. In another embodiment, the external member can be an optical grating, an anti-dust cover or a lens.′

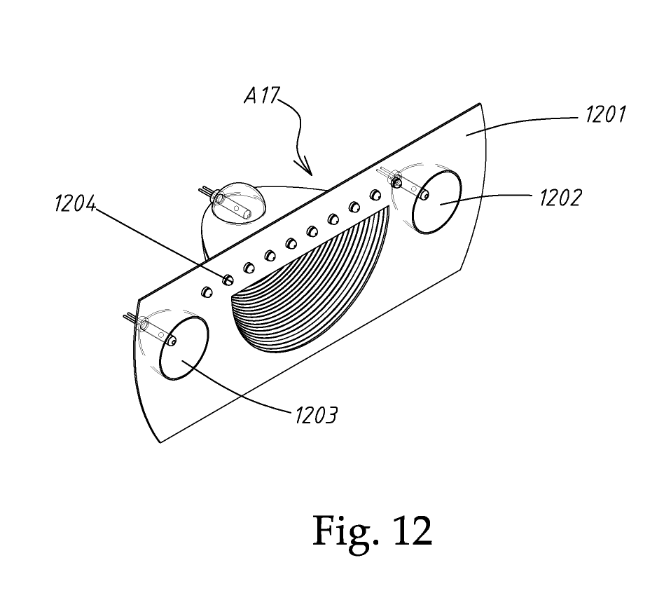

Referring to FIG. 12, a reflecting structure includes a reflector A17. A panel 1201 is connected to an edge of the reflector A17. A turn warning light 1202, a fog warning light 1203 and a LED width indicator 1204 are disposed on the panel 1201. The reflector A17 has a structure similar to the reflector A01, and the reflectors in the previous embodiment can be modified to connect to a panel.

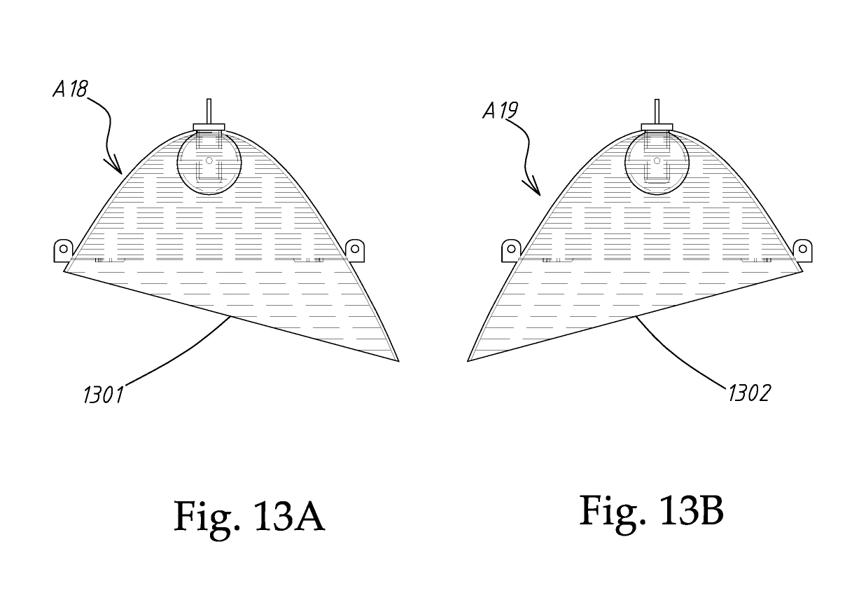

Referring to FIG. 13A, a reflector A18 has an inclined surface 1301, which is higher at left hand side than at the right hand side, on a bottom thereof. Referring to FIG. 13B, a reflector A19 has an inclined surface 1302, which is higher at left hand side than at the right hand side, on a bottom thereof. The reflectors A18 and A19 is symmetrical and can be mounted to a vehicle to match a smooth front panel (not shown). The reflectors in the previous embodiments can be modified to have such an inclined surface.

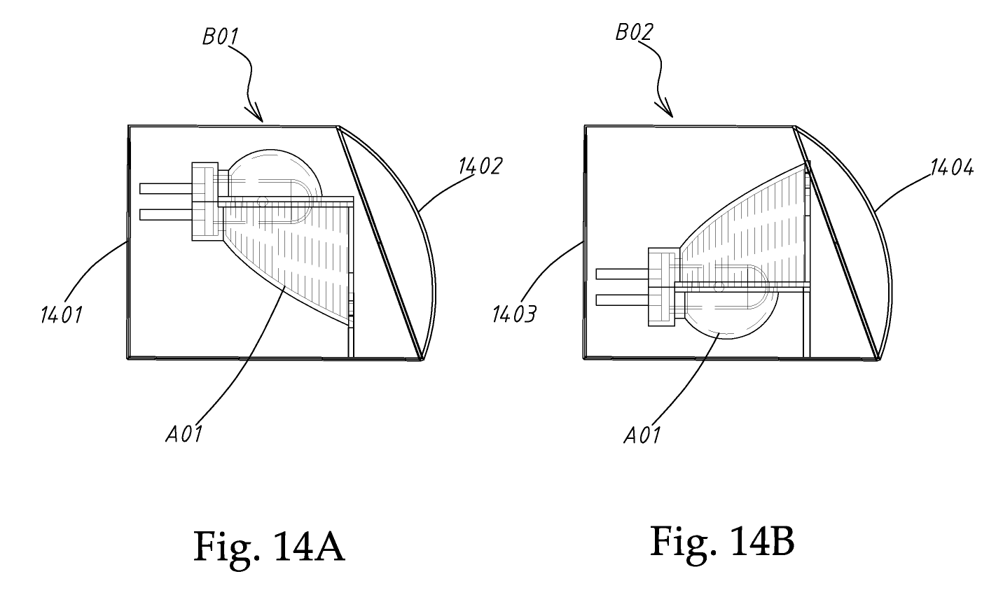

Referring to FIGS. 14A and 14B, a lamp B01 has an anti-dust cover 1401. At least one transparent plate 1402 is disposed on one lateral side of the anti-dust cover 1401 for light passing through. The reflector A01 is disposed in the anti-dust cover 1401. A lamp B02 has an anti-dust cover 1403, and at least one transparent plate 1404 is disposed on one lateral side of the anti-dust cover 1403. The reflector A01 is upside down disposed in the anti-dust cover 1403. The anti-dust covers 1401 and 1403 can have a through hole or movable open/close structure for mounting or repair a light source.

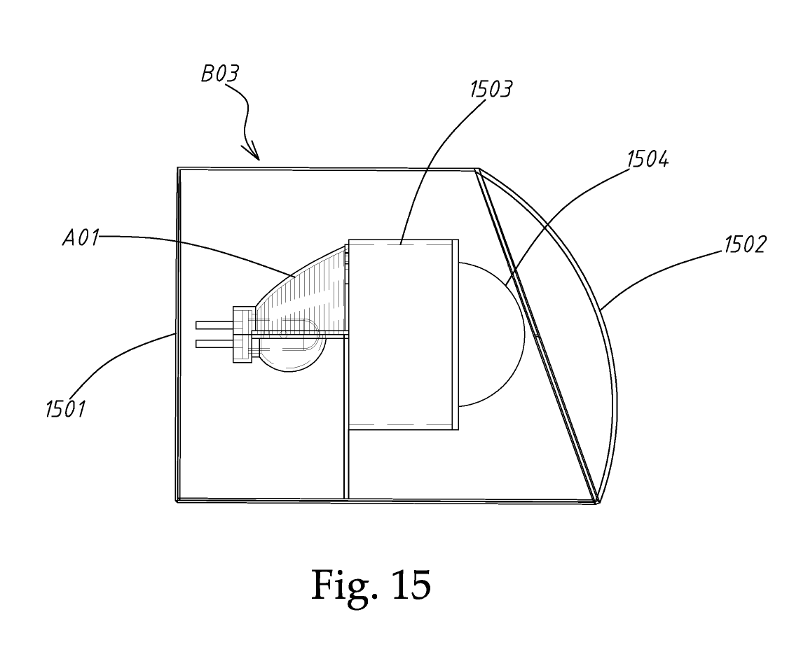

Referring to FIG. 15, a lamp B03 has an anti-dust cover 1501. A transparent plate 1502 is disposed on one lateral side of the anti-dust cover 1501. The reflector A01 is disposed upside down in the anti-dust cover 1501. In another embodiment, the reflector A01 can be joined to one end surface of a hollow cylindrical frame 1503, and the other end surface of the hollow cylindrical frame 1503 is joined to a lens. The anti-dust cover 1501 can have a through hole or movable open/close structure for mounting or repair a light source.

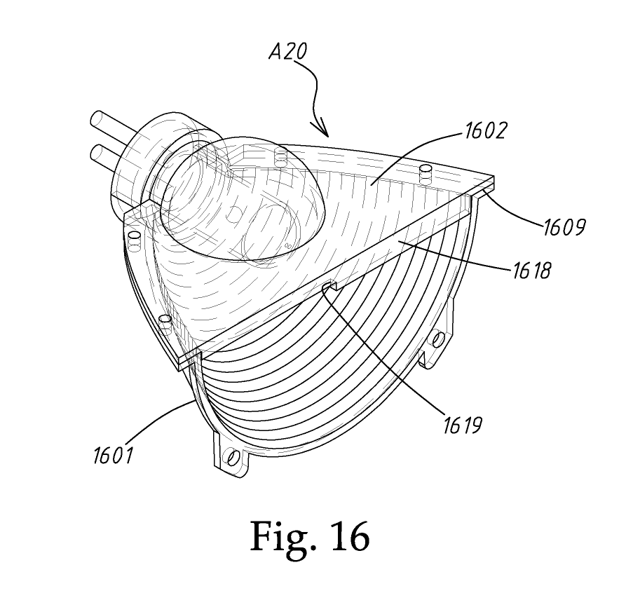

Referring to FIG. 16, a reflecting structure of the invention includes a reflector A20. The reflector A20 includes a main body 1601 and a light intercepting plate 1602. The reflector A20 has a structure similar to the reflector A01 of FIGS. 2A and 2B. The reflector A20 further includes a wall 1618 with uneven height. The wall 1618 extends from a bottom of light intercepting plate 1602 and has a vertical second light intercepting surface 1619. The second light intercepting surface 1619 enable light to have a higher projection angle on one half portion and a lower projection angle on the other half portion.

Each of the arc-shaped inclined surfaces is enlarged in the figures of the invention for clarity. In real application, many tiny arc-shaped inclined surfaces are connected to each other to form a curve surface.

The lamp of the invention is particularly suitable for head light of vehicles to reflect light from a light source to become effective illuminating light and prevent light from dazzling a driver in a coming car. The lamp of the invention can also be applied to road lamp and disposed on guardrails on a rod shoulder.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A reflecting structure of a lamp, comprising:
at least one light source; and
at least one reflector in which the light source is disposed to emit light, wherein the reflector comprises a light intercepting plate and a main body joined to the light intercepting plate; the light intercepting plate comprises at least one light intercepting surface, at least one reflecting surface extending from the light intercepting plane perpendicularly toward an outer surface of the light intercepting plate and a first positioning structure; the main body is joined to the light intercepting surface and comprises a second positioning structure and a plurality of reflecting inner surfaces reflecting light direct from the light source and light reflected by the reflecting surface, and each of the reflecting inner surfaces has an inclined angle different from the inclined angle of other of the reflecting inner surfaces.

2. The reflecting structure as claimed in claim 1, wherein the light intercepting plate comprises at least one horizontal light intercepting plane and at least one inclined light intercepting plane.

3. The reflecting structure as claimed in claim 1, wherein the light intercepting surface comprises at least one arc-shaped reflecting surface.

4. The reflecting structure as claimed in claim 1, wherein the light intercepting surface comprises at least one curved reflecting surface.

5. The reflecting structure as claimed in claim 1, wherein the light intercepting surface comprises at least one arc-shaped surface, and at least one conical reflecting surface extending from the light intercepting plane to the outer surface of the light intercepting plate perpendicular to the light intercepting plane is formed in front of the arc-shaped surface; the conical reflecting surface comprises a plurality of arc-shaped inclined surfaces connected to each other, and each of the arc-shaped inclined surfaces has an inclined angle gradually increased from the arc-shaped inclined surface at a bottom of the conical reflecting surface to the arc-shaped inclined surface at a top of the conical reflecting surface.

6. The reflecting structure as claimed in claim 1, wherein the light intercepting surface comprises at least one arc-shaped surface, and at least one conical reflecting surface extending from the light intercepting plane to the outer surface of the light intercepting plate perpendicular to the light intercepting plane is formed in front of the arc-shaped surface and on one side of a perpendicular light intercepting surface disposed on the light intercepting plate; the conical reflecting surface comprises a plurality of arc-shaped inclined surfaces connected to each other, and each of the arc-shaped inclined surfaces has an inclined angle gradually increased from the arc-shaped inclined surface at a bottom of the conical reflecting surface to the arc-shaped inclined surface at a top of the conical reflecting surface.

7. The reflecting structure as claimed in claim 1, wherein the reflecting surface comprises at least one arc-shaped surface, and a movable light intercepting surface connected to an electromagnet is formed in front of the arc-shaped surface and at least one conical reflecting surface extending from the movable light intercepting surface to the outer surface of the light intercepting plate perpendicular to the light intercepting plane is formed; the conical reflecting surface comprises a plurality of arc-shaped inclined surfaces connected to each other, and each of the arc-shaped inclined surfaces has an inclined angle gradually increased from the arc-shaped inclined surface at a bottom of the conical reflecting surface to the arc-shaped inclined surface at a top of the conical reflecting surface.

8. The reflecting structure as claimed in claim 1, wherein the main body comprises at least one conical reflecting surface, and the conical reflecting surface comprises a plurality of arc-shaped inclined surfaces connected to each other, and each of the arc-shaped inclined surfaces has an inclined angle gradually increased from the arc-shaped inclined surface at a bottom of the conical reflecting surface to the arc-shaped inclined surface at a top of the conical reflecting surface; two planes extend outwards from two lateral sides of the main body respectively.

9. The reflecting structure as claimed in claim 8 further comprising a middle semi-circular inclined surface extending from a bottom of the main body toward an outer side of the bottom of the main body slantly and at least one bottom conical curved surface extending from a bottom of the middle semi-circular inclined surface toward an inner side of the bottom of the main body slantly, wherein the conical reflecting surface comprises a plurality of arced inclined surfaces connected to each other, and each of the arced inclined surfaces has an inclined angle gradually increased from the arced inclined surface at a bottom of the conical reflecting surface to the arced inclined surface at a top of the conical reflecting surface; two planes extend outwards from two lateral sides of the main body respectively.

10. The reflecting structure as claimed in claim 1 further comprising a panel extending from a bottom of the reflector and at least one warning light source disposed on the panel.

11. The reflecting structure as claimed in claim 1, wherein the reflector is disposed upside down in an anti-dust cover comprising at least one transparent plate.

12. The reflecting structure as claimed in claim 12, wherein a bottom of the reflector is connected to an end surface of a hollow cylindrical frame, and another end surface of the hollow cylindrical frame is connected to a lens.

13. The reflecting structure as claimed in claim 1, wherein a bottom of the reflector is connected to a transparent plate.

14. The reflecting structure as claimed in claim 1, wherein a bottom of the reflector is connected to a light emitting module.

15. The reflecting structure as claimed in claim 1, wherein the reflector comprises a bottom with uneven height.

16. The reflecting structure as claimed in claim 1, wherein the reflector further comprises a plurality of fins disposed on the outer surface of the light intercepting plate.

17. The reflecting structure as claimed in claim 1, wherein the light intercepting plate comprises at least one horizontal light intercepting surface and at least one vertical light intercepting surface with uneven height, and the vertical light intercepting surface is disposed on an inner surface of a bottom of the light intercepting plate and perpendicular to the horizontal light intercepting surface.

18. A reflecting structure of a lamp, comprising:
at least one light source; and
at least one reflector in which the light source is disposed to emit light, wherein the reflector comprises at least one light intercepting plate comprising a plurality of reflecting surfaces; the light intercepting plate further comprises at least one light intercepting plane and two conical curved reflecting surfaces formed on an upper side and a lower side of the light intercepting plan; each of the conical curved reflecting surface comprises a plurality of arced inclined surfaces connected to each other, and each of the arced inclined surfaces has an inclined angle gradually increased from the arced inclined surface at a bottom of the conical reflecting surface to the arced inclined surface at a top of the conical reflecting surface; the conical curved reflecting surfaces are non-symmetrical with the light intercepting plane; the reflector comprises at least one positioning structure.

19. The reflecting structure as claimed in claim 18, wherein the light intercepting plate further comprises at least one horizontal light intercepting plane and at least one inclined light intercepting plane.

20. The reflecting structure as claimed in claim 18, wherein the reflector further comprises at least one arc-shaped reflecting surface disposed on a vertex of the conical curved reflecting surface and above the light intercepting plane.

21. The reflecting structure as claimed in claim 18, wherein the reflector further comprises at least one arc-shaped reflecting surface disposed on a vertex portion of the conical curved reflecting surface and below the light intercepting plane.

22. The reflecting structure as claimed in claim 18, further comprising a panel extending from a bottom of the reflector and at least one alarm light source disposed on the panel.

23. The reflecting structure as claimed in claim 18, wherein a bottom of the reflector is connected to an end surface of a hollow cylindrical frame, and another end surface of the hollow cylindrical frame is connected to a lens; the reflector is disposed in an anti-dust cover comprising at least one transparent member.

24. The reflecting structure as claimed in claim 18, wherein a bottom of the reflector is connected to a transparent plate.

25. The reflecting structure as claimed in claim 18, wherein a bottom of the reflector is connected to a light emitting module.

26. The reflecting structure as claimed in claim 18, wherein the reflector comprises a bottom with uneven height.
